(19) United States
(12) Patent Application Publication
(10) Pub. No.: US 2025/0256222 A1
(43) Pub. Date: Aug. 14, 2025

(54) METHOD OF TREATING AN OIL SPILL

(71) Applicant: King Fahd University of Petroleum and Minerals, Dhahran (SA)

(72) Inventors: Ali A. BINABDI, Dhahran (SA); Theis I. SOLLING, Dhahran (SA)

(73) Assignee: King Fahd University of Petroleum and Minerals, Dhahran (SA)

(21) Appl. No.: 18/667,793

(22) Filed: May 17, 2024

Related U.S. Application Data
(60) Provisional application No. 63/552,345, filed on Feb. 12, 2024.

(51) Int. Cl. B01D 17/04; C02F 1/28; C02F 101/32; C02F 103/00; C02F 103/08; E02B 15/04; E02B 15/08

(52) U.S. Cl. CPC B01D 17/047; C02F 1/288; E02B 15/041; E02B 15/046; E02B 15/08; C02F 1/281; C02F 1/285; C02F 2101/32; C02F 2103/001; C02F 2103/08

(57) ABSTRACT

A method of treating an oil spill including first making a formulation. The formulation includes mixing an acid and a solvent to form a first solution, mixing a zinc (II) salt and water to form a second solution, and adding the second solution to the first solution to form the formulation. The acid includes a carboxylic acid group and at least 10 carbon atoms. The first solution includes 1 weight percentage (wt. %) to 10 wt. % of the acid relative to a total weight of the first solution, and the second solution includes 1 to 10 moles of the zinc (II) salt per liter of the water. The method further includes contacting the formulation with the oil spill. The oil spill includes an aqueous medium and an oily layer on the aqueous medium and the contacting coalesces the oily layer.

### CROSS REFERENCE TO RELATED APPLICATIONS

This application is related to provisional application 63/552,345, filed on Feb. 12, 2024, incorporated herein by reference.

### STATEMENT OF PRIOR DISCLOSURE BY INVENTOR

Aspects of the present disclosure are described in A. A. Binabdi, T. I. Solling, A. M. El Zohry, S. Ayirala, A. Gmira, and A. A. Yousef “Fundamentals of crystallization at oil-brine interfaces for conformance control and oil spill remediation applications”; Geoenergy Science and Engineering; 2023; 227; 211930, incorporated herein by reference in its entirety.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed towards chemical interventions for oil spills, and more particularly, directed towards a method of treating an oil spill using a chemical formulation.

### Description of Related Art

The “background” description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

Presently, oil spills are a major environmental concern. In general, when oil accidentally spills into the ocean, it may adversely affect sea creatures and the overall oceanic environment. Oil spills may be characterized as small when an accidental spillage occurs during the refueling of sea transport. However, large spillage may occur due to a malfunction in oil pipelines, sinking of oil tanker ships, and during drilling operations.

A plurality of approaches exist in order to detect and contain oil spills, such as, but not limited to, physical removal, chemical removal, and oil burning. Physical removal refers to containing oil spills using boom barriers and skimming the oil off the surface of the ocean using boats. Chemical removal refers to breaking down oil into non-harmful substances at the surface of the ocean. Chemical oil spill remedies previously involved wettability changing agents and gelation. Further, oil burning may be implemented to burn off the oil spill at a site of the oil spill.

Interfacial surface tension (IFT) is a vital parameter while implementing chemical oil removal agents. In general, the IFT expresses a stress that is induced by having two repelling fluids next to each other. The stress is influenced by molecular interactions at the interface. These interactions are determined by interfacial molecular structure. Further, IFT is a property that plays a major role in the efficiency of two-phase flow through a porous medium such as an oil reservoir. The interfacial properties also impact emulsification in general. To date, organic acids and a brine medium are used to mitigate oil spill crises using chemical interventions. An interfacial surface between the oil spill and a chemical formulation used in chemical intervention may be referred to as the interface. In particular, the structure of the organic acid plays a key role in determining whether or not the interface solidifies. Further, factors such as the polarity of surface-active components and relative solubility of surface-active components in two phases of oil and chemical formulation may also be noteworthy. Furthermore, the nature of the brine is also central in determining when crystallization takes place.

Presently, an inorganic chemical oil spill remedy is sought with non-gelation, non-polymer-based methods that rely only on interfacial inorganically induced changes to tackle conformance and oil spills. However, the present methods are inefficient, energy-dense, and detrimental to the environment. Thus, there arises a need to implement better oil spill containment and cleaning strategies. Hence, it is one object of the present disclosure to provide a method of treating an oil spill that may circumvent the aforementioned drawbacks of the prior arts.

### SUMMARY

In an exemplary embodiment, a method of treating an oil spill is described. The method includes making a formulation. The formulation is prepared by mixing an acid and a solvent to form a first solution, mixing a zinc (II) salt and water to form a second solution, and adding the second solution to the first solution to form the formulation. The acid includes a carboxylic acid group and at least 10 carbon atoms. The first solution includes 1 weight percentage (wt. %) to 10 wt. % of the acid relative to a total weight of the first solution, and the second solution includes 1 to 10 moles of the zinc (II) salt per liter of the water. The method further includes contacting the formulation with the oil spill. The oil spill includes an aqueous medium and an oily layer on the aqueous medium and the contacting coalesces the oily layer.

In some embodiments, the zinc (II) salt is zinc (II) chloride, and during the contacting, in-situ crystallization of the zinc (II) chloride occurs at an interface of the aqueous medium and the oily layer to form a crystalline confinement around hydrocarbon droplets in the oily layer.

In some embodiments, the acid includes the carboxylic acid group and 10-14 carbon atoms in a straight chain.

In some embodiments, the acid is dodecanoic acid.

In some embodiments, the second solution further includes at least one selected from a copper (II) salt, a nickel (II) salt, an iron (II) salt, a manganese (II) salt, a niobium (V) salt, a neodymium (III) salt, a cerium (III) salt, and a chromium (III) salt.

In some embodiments, the second solution further includes a copper (II) salt.

In some embodiments, the first solution includes 1 to 3 wt. % of the acid relative to a total weight of the first solution.

In some embodiments, the second solution includes 2-3 moles of the zinc (II) salt per liter of the water.

In some embodiments, the solvent is selected from acetone, glycerol, and ethanol.

In some embodiments, the method includes adding the second solution to the first solution in a drop wise manner to form the formulation.

In some embodiments, the first solution is saturated with the second solution in the formulation.

In some embodiments, the method includes contacting the formulation with the oil spill within 30 minutes after the formulation is made.

In some embodiments, the formulation does not include a gel.

In some embodiments, the formulation does not include a polymer.

In some embodiments, the oily layer is crude oil.

In some embodiments, the coalesced oily layer has a total surface area at least 10% smaller than a surface area of the oily layer prior to contacting the formulation with the oil spill.

In some embodiments, the method includes contacting the formulation with the oil spill by adding a volume of the formulation that is 1 to 50% of a total volume of the oily layer.

In some embodiments, the method further includes deploying a first drone to assess a size of the oil spill prior to the making the formulation.

In some embodiments, the method further includes deploying a second drone containing the formulation and the second drone contacts the formulation with the oil spill.

In some embodiments, the method further includes deploying a boat to collect the coalesced oily layer.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method of treating an oil spill, according to certain embodiments.

FIG. 1B depicts the size of an oily layer before applying a formulation, according to certain embodiments.

FIG. 1C depicts a process of minimizing the area of the oil spill, according to certain embodiments.

FIGS. 1D-1I depicts the exemplary process of minimizing the area of the oil spill, according to certain embodiments.

FIGS. 1J1N depicts the exemplary process of minimizing the area of the oil spill, according to certain embodiments.

FIG. 1O depicts oily layer size after applying the formulation, according to certain embodiments.

FIG. 2 shows chemical structures of a plurality of carboxylic acids used in the formulation, according to certain embodiments.

FIG. 3A is an image showing an alkane drop placed in a polar medium, according to certain embodiments.

FIG. 3B is an image showing a growth of crystals on the alkane drop of FIG. 3A after a time period of 180 seconds, according to certain embodiments.

FIG. 4A is an optical image showing crystallization between carboxylic acid (C12) and copper ion (Cu²⁺), according to certain embodiments.

FIG. 4B is an optical image showing crystallization between C12 and neodymium ion (Nd³⁺), according to certain embodiments.

FIG. 4C is an optical image showing crystallization between C12 and cerium ion (Ce²⁺), according to certain embodiments.

FIG. 4D is an optical image showing crystals of Cu²⁺ at an interface, according to certain embodiments.

FIG. 4E is an optical image showing crystals of Nd³⁺ at an interface, according to certain embodiments.

FIG. 4F is an optical image showing crystals of Ce²⁺ at an interface, according to certain embodiments.

FIG. 5A is a graph depicting temporal evolution of interfacial surface tension (IFT) between a 1.6 weight percentage (wt. %) solution of dodecanoic acid and 0.1 M solution of Ce³⁺ brine, according to certain embodiments.

FIG. 5B is a graph depicting temporal evolution of IFT between the 1.6 wt. % solution of dodecanoic acid and 0.1 M solution of Cu²⁺ brine, according to certain embodiments.

FIG. 5C is a graph depicting temporal evolution of IFT between the 1.6 wt. % solution of dodecanoic acid and 0.1 M solution of Nd³⁺ brine, according to certain embodiments.

FIG. 5D is a graph depicting temporal evolution of IFT between the 1.6 wt. % solution of dodecanoic acid and 0.1 M solution of Zn²⁺ brine, according to certain embodiments.

FIG. 5E is a graph depicting temporal evolution of IFT between the 1.6 wt. % solution of dodecanoic acid and 0.1 M solution of Cr³⁺ brine, according to certain embodiments.

FIG. 5F is a graph depicting temporal evolution of IFT between the 1.6 wt. % solution of dodecanoic acid and 0.1 M solution of Fe²⁺ brine, according to certain embodiments.

FIG. 5G is a graph depicting temporal evolution of IFT between the 1.6 wt. % solution of dodecanoic acid and 0.1 M solution of Li²⁺ brine, according to certain embodiments.

FIG. 5H is a graph depicting temporal evolution of IFT between the 1.6 wt. % solution of dodecanoic acid and 0.1 M solution of Mn²⁺ brine, according to certain embodiments.

FIG. 5I is a graph depicting temporal evolution of IFT between the 1.6 wt. % solution of dodecanoic acid and 0.1 M solution of Nb⁵⁺ brine, according to certain embodiments.

FIG. 5J is a graph depicting temporal evolution of IFT between the 1.6 wt. % solution of dodecanoic acid and 0.1 M solution of Ni²⁺ brine, according to certain embodiments.

FIG. 6 are schematic illustrations showing calculated geometrics of transition metal hexa-aquo and tetra-aquo ions in interatomic distances in Armstrong (Å), according to certain embodiments.

FIG. 7 shows a crystal structure of a crystal batch isolated from a solidified interface between oil and brine phases, according to certain embodiments.

FIG. 8A is a graph of a temporal evolution of the IFT of crude oil at a total acid number (TAN) of 1.9, according to certain embodiments.

FIG. 8B is a graph of a temporal evolution of the IFT of crude oil at a TAN of 2.8, according to certain embodiments.

FIG. 8C is a graph of a temporal evolution of the IFT of crude oil at a TAN of 3.3, according to certain embodiments.

FIG. 8D is an optical image depicting confinement of oil droplet with a Zn²⁺ crystal layering and mass transport effect, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

Aspects of the present disclosure are directed towards a cost-effective method for containing crude oil spills using a formulation of zinc ions and fatty acid chains. The method is based on an interfacial-driven phenomenon and promotes in-situ crystallization of zinc ions at the oil/brine interface, leading to hydrocarbon drop confinement in a smaller area.

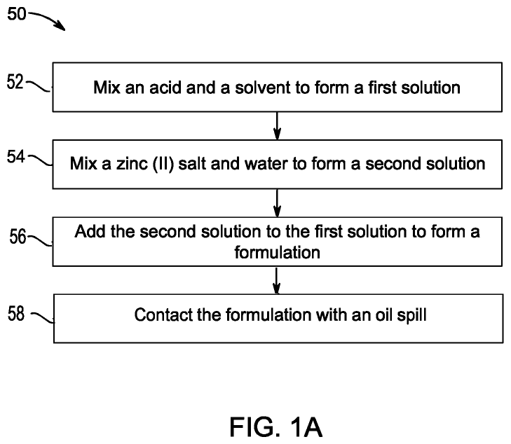

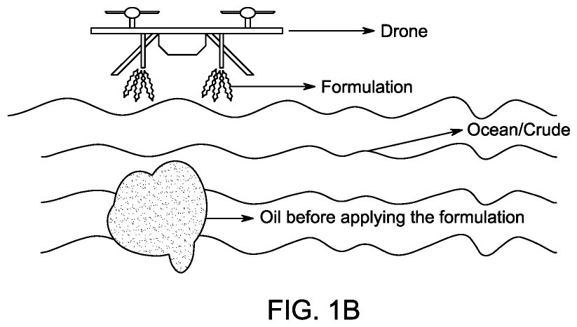

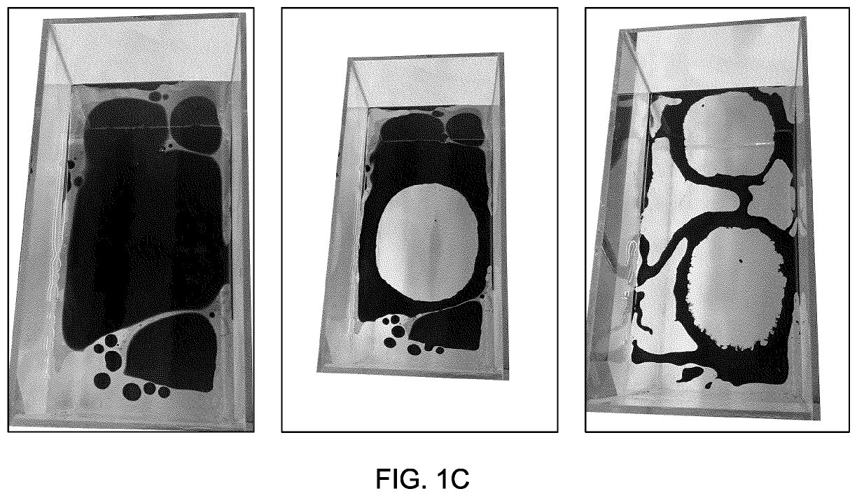

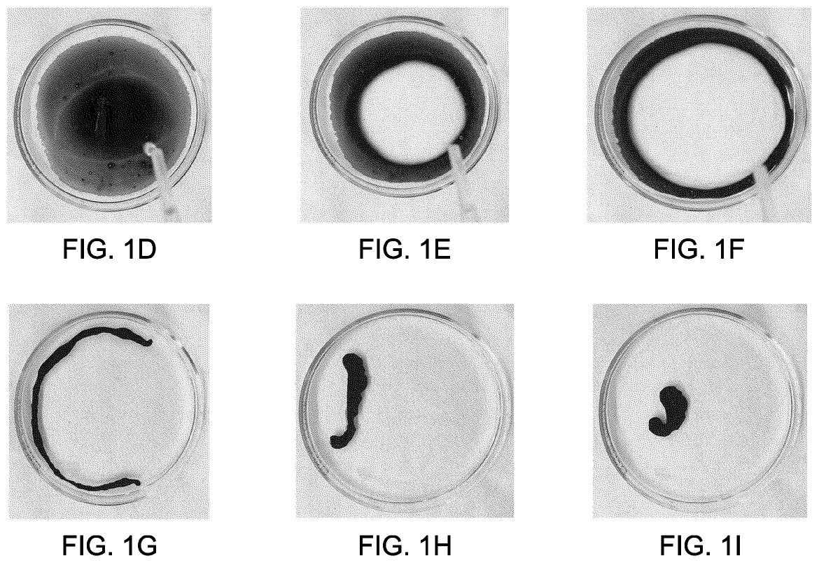

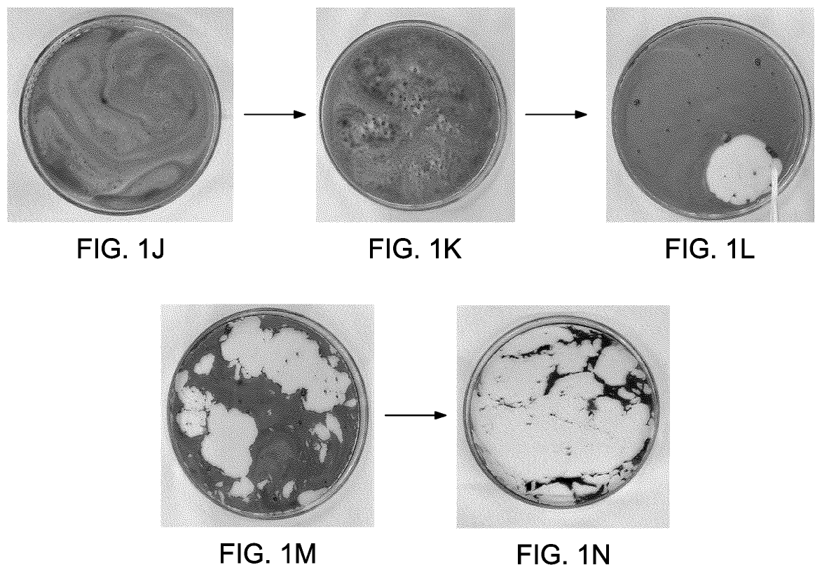

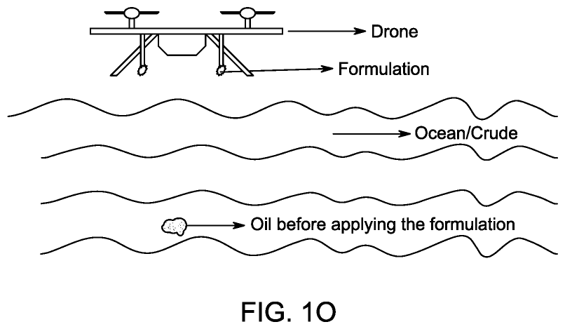

Referring to FIG. 1A, a method 50 of treating an oil spill, including making a formulation, is illustrated, according to certain embodiments. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure. However, in a preferred embodiment, the steps are performed in the described order.

At step 52, the method 50 includes mixing an acid and a solvent to form a first solution. In some embodiments, the mixing can be done by stirring, swirling, sonicating, or a combination thereof may be employed to form the first solution. In some embodiments, the mixing is performed at an elevated temperature below the boiling point of the solvent such as 30-50° C., preferably 35-45° C., or about 40° C. In some embodiments, the acid fully dissolves in the solvent.

In some embodiments, the acid includes a carboxylic acid group and at least 10 carbon atoms, preferably 10-20, 11-19, 12-18, 13-17, 14-16 or about 15 carbon atoms. As used herein a carboxylic acid group has a structure of R—COOH, where R includes the at least 9 carbon atoms. In some embodiments, the acid includes the carboxylic acid group and 10-14 carbon atoms, preferably 11, 12 or 13 carbon atoms in a straight chain, i.e., there is no branching in the carbon chain. In some embodiments, the acid may include, but is not limited to, decanoic acid, dodecanoic acid (also referred to as lauric acid), tetradecanoic acid, hexadecanoic acid, octadecanoic acid, icosanoic acid. In some embodiments, the acid is dodecanoic acid or lauric acid.

In some embodiments, the solvent includes tetrahydrofuran, ethyl acetate, dimethylformamide, acetonitrile, acetone, dimethyl sulfoxide, nitromethane, propylene carbonate, ethanol, formic acid, n-butanol, methanol, acetic acid, or any combination thereof. In some embodiments, the solvent is selected from acetone, glycerol, and ethanol. In a preferred embodiment, the acid is soluble in the solvent. In some embodiments, the dodecanoic acid is diluted into acetone. In some embodiments, the first solution includes 1 weight percentage (wt. %) to 10 wt. % of the acid relative to the total weight of the first solution, preferably 2-9 wt. %, 3-8 wt. %, 4-7 wt. %, or 5-6 wt. %. In some embodiments, the first solution includes 1 to 3 wt. % of the acid relative to the total weight of the first solution. For example, 1.7-3 weight percent of lauric acid in 5-10 milliliters (ml) of acetone.

At step 54, the method 50 includes mixing a zinc (II) salt and water to form a second solution. In some embodiments, the mixing can be done by stirring, swirling, sonicating, or a combination thereof may be employed to form the resultant mixture. In some embodiments, the mixing is performed at an elevated temperature below the boiling point of the water such as 30-90° C., preferably 40-80° C., 50-70° C., or about 60° C. In some embodiments, the zinc salt fully dissolves in the water.

The zinc (II) salt includes zinc acetate (Zn(OAc)₂), zinc chloride (ZnCl₂), zinc hydroxide (Zn(OH)₂), zinc nitrate (Zn(NO₃)₂), zinc sulphate, zinc phosphate, zinc molybdate, zinc chromate, zinc ricinoleate. In some embodiments, the zinc (II) salt is zinc (II) chloride. The water may be tap water, distilled water, bi-distilled water, deionized water, deionized distilled water, reverse osmosis water, and/or some other water. The second solution includes 1 to 10 moles of zinc (II) salt per liter of water, preferably 2-9 moles, 3-8 moles, 4-7 moles, or 5-6 moles. In some embodiments, the second solution includes 2-3 moles of the zinc (II) salt per liter of water.

In some embodiments, the second solution further includes at least one selected from a copper (II) salt, a nickel (II) salt, an iron (II) salt, a manganese (II) salt, a niobium (V) salt, a neodymium (III) salt, a cerium (III) salt, and a chromium (III) salt. In a preferred embodiment, the second solution only includes a zinc salt (II) in water. Of the described salts, zinc is the most environmentally friendly, as other metals may have detrimental effects on the environment.

Suitable examples of copper salts include copper(II) sulfate, copper(II) chloride, copper(II) hydroxide, copper(II) nitrate, copper(II) oxide, copper(II) acetate, copper(II) fluoride, copper(II) bromide, copper(II) carbonate, copper(II) carbonate hydroxide, copper(II) chlorate, copper(II) arsenate, copper(II) azide, copper(II) acetylacetonate, copper(II) aspirinate, copper(II) cyanurate, copper(II) glycinate, copper(II) phosphate, copper(II) perchlorate, copper(II) selenite, copper(II) sulfide, copper(II) triflate, copper(II) thiocyanate, copper(II) tetrafluoroborate, copper(II) acetate triarsenite, copper(II) benzoate, copper(II) arsenite, copper(II) chromite, copper(II) gluconate, copper(II) peroxide, copper(II) usnate, copper(II) oxychloride, copper(II) naproxen, copper(II) ibuprofenate.

Suitable examples of iron salts include iron(II) acetate, iron(II) bromide, iron(II) carbonate, iron(II) chloride, iron(II) chromite, iron(II) citrate, iron(II) cyanide, iron(II) fluoride, iron(II) fumarate, iron(II) gluconate, iron(II) hydride, iron(II) hydroxide, iron(II) iodide, iron(II) lactate, iron(II) molybdate, iron(II) nitrate, iron(II) oxalate. In some embodiments, the second solution further includes a copper(II) salt. Suitable examples of nickel salts include nickel(II) sulfate hexahydrate, nickel(II) iodide, nickel(II) bromide, nickel(II) nitrate hexahydrate, nickel(II) chloride, nickel(II) acetate tetrahydrate, nickel(II) sulfate, nickel(II) sulfamate tetrahydrate, nickel(II) bromide trihydrate, nickel(II) chloride hydrate, nickel(II) bromide hydrate, nickel(II) hydroxide, nickel(II) sulfate heptahydrate.

Suitable examples of manganese salts include manganese acetate, manganese carbonate, manganese chloride, manganese tetroxide, manganese dioxide, potassium permanganate, manganese gluconate, manganese oxide.

Suitable example of neodymium (III) salt is neodymium (III) carbonate. Suitable examples of cerium (III) salt include cerium (III) chloride (CeCl₃), cerium oxalate, cerium (III) nitrate hexahydrate, cerium (III) sulfate, cerium (III) trifluoromethanesulfonate, cerium (III) nitrate hexahydrate.

Suitable examples of chromium (III) salt include chromium (II) oxalate, chromium (III) acetate, chromium (III) carbonate, chromium (III) chloride hexahydrate, chromium (III) chloride, chromium (III) hydroxide, chromium (III) nitrate nonahydrate, chromium (III) oxide, chromium (III) potassium sulphate dodecahydrate, chromium (III) sulphate, chromium fluoride, and/or a combination thereof.

At step 56, the method 50 includes adding the second solution to the first solution to form the formulation. In some embodiments, the adding is dropwise. In some embodiments, the first solution is saturated with the second solution in the formulation. In other words, the first and second solutions form one solution in the formulation and are not separated. Although the organic phase (first solution) and the inorganic phase (second solution) are typically not miscible and will separate over time, if used immediately after prepared, the formulation is one miscible solution. Adding the solutions dropwise allows for the solutions to mix without forming separate layers.

In some embodiments, the formulation does not include a gel, a gelling agent, or a polymer. Gelling agents or polymers, also known as solidifiers, are chemicals that react with oil to form rubber-like solids. With small spills, these chemicals can be applied by hand and left to mix on their own. For treating larger spills, the chemicals are applied to the oil, then mixed in by the force of high-pressure water streams. Examples include but are not limited to low molecular weight organogels. polyacrylamides (HPAM), superabsorbent polymers, cross-linked polyacrylic acid, and preformed particle gels.

At step 58, method 50 includes contacting the formulation with an oil spill. In a preferred embodiment, as described previously to prevent the separation of organic and inorganic layers, the contacting is within 30 minutes (mins) of preparation of the formulation, preferably with 25 mins, 20 mins, 15 mins, 10 mins, 5 mins, or 1 min. This time is defined from the time after the first solution is saturated with the second solution.

An oil spill is the spillage of oil (for example, petrol, diesel, fuel, crude oil, or the like) in an aqueous medium, resulting in forming an oily layer on the aqueous medium. In a preferred embodiment, the oil is crude oil. The aqueous medium may include saltwater, rain, acid solutions, base solutions, and salt solutions.

The volume of the formulation that is added to the oily layer is typically in a range of 1 to 50% of the total volume of the oily layer, preferably 5-45%, 10-40%, 15-35%, or 20-30%. For example, if 10 L of oil is spilled, 1 L of the formulation (10%) is contacted.

Contacting the formulation with the oil spill coalesces the oily layer. During contact, in-situ crystallization of the zinc (II) occurs at an interface of the aqueous medium and the oily layer to form a crystalline confinement around hydrocarbon droplets in the oily layer, causing the droplet to shrink. The formed boundary will act against the extension/spreading of the oil mass, which can be easily skimmed during clean-up operations.

In some embodiments, the coalesced oily layer has a total surface area of at least 10% smaller than the surface area of the oily layer prior to contacting the formulation with the oil spill, preferably 20%, 30%, 40%, 50%, 60%, 70%, 80%, 90%, or 95% smaller. For example, if the surface area of the oily layer in the beginning is 100 m², after contacting with the formulation, the surface area of the oil layer is 40 m² (60%).

In some embodiments, method 50 includes deploying a first drone to assess the size of the oil spill prior to making the formulation, as shown in FIG. 1B. Based on the size of the oil spill, a sufficient amount of the formulation can then be produced.

The method 50 also includes deploying a second drone containing the formulation, which contacts the formulation with the oil spill. In some embodiment, the second drone drops the formulation onto the oil spill while in the air. The formulation shrinks the oily layer and minimizes its spread (as shown in FIG. 1O). The method 50 also includes deploying a boat to collect the coalesced oily layer. The layer can be collected by any method known in the art including but not limited to skimming the oil off the surface.

The method of the present disclosure offers an advantage over traditional methods that involve waiting for specialized response teams to arrive, often after the oil has already spread extensively and reached shorelines. Further, the method ensures a rapid and proactive response, preventing further environmental damage and demonstrating a marked improvement in overall efficiency.

While not wishing to be bound to a single theory, it is thought that the use of the Zn²⁺ not only provides a more environmentally friendly component but also provides a unique crystallization propensity due to the electronic orbital that acts as an acceptor on the cation, particularly an empty s orbital, resulting in crystalline confinement around the hydrocarbon droplet to shrink the droplet significantly. In addition, the lauric acid provides a combination of binding strength of the cation with the acid, and favorable orientation of the acid at the interface. Only certain acids give rise to crystallization such as, those with a chain that is structured to fit into the bulk oil to orient and thereby place the acid group at the interface. Further, the order of combining the components was significant in order to provide a formulation where both the acid and the zinc are dissolved, and the solutions of the zinc salt and acid are miscible.

### EXAMPLES

The following examples demonstrate a method of treating an oil spill using a chemical formulation. The examples are provided solely for illustration and are not to be construed as limitations of the present disclosure, as many variations thereof are possible without departing from the spirit and scope of the present disclosure.

### Example 1: Force Tensiometry and Optical Microscopy

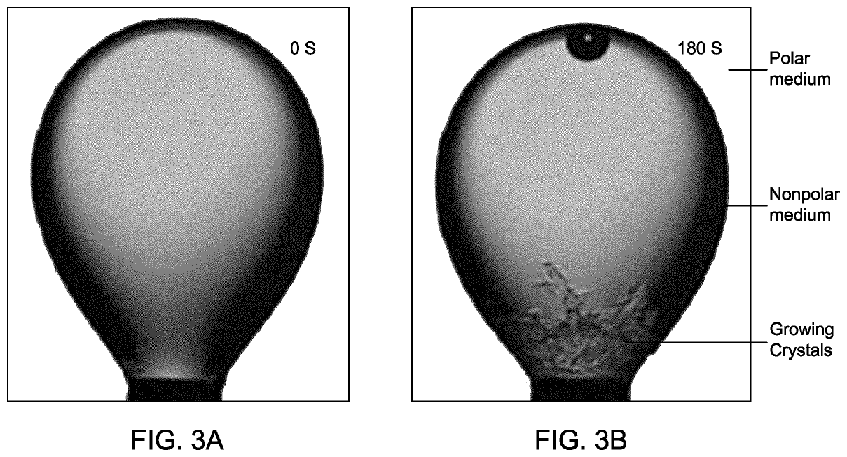

Interfacial surface tension (IFT) measurements were conducted on an Attension Theta optical tensiometer instrument from Biolin scientific, employing buoyant drop shape analyses. The IFT was calculated by analyzing a droplet shape in combination with the density difference between two phases. Each measurement was conducted over a time span of one hour (h) and at least four days to ensure the reproducibility of measured values. IFT dynamics were measured for a few hours in most cases, and the short times were used in those cases where it was not possible to maintain a stable droplet. The experiments were conducted in a buoyant drop (BD) mode (dodecane-surfactant in a reservoir of brine), an example of which is depicted in FIGS. 3A and 3B where a free-standing drop is residing in a brine solution. In cases where crystallization was induced, an appearance was described from a visual inspection and crystals were further studied with optical microscopy. The optical microscopy was conducted in a standard setup where the brine was placed in a droplet on a microscope slide with a subsequent addition of a dodecane/acid solution. The result was then observed at 30 times magnification after approximately 5 minutes with a Leica DM2500 led microscope with standard non-polarized reflected light.

### Example 2: Computational Details

Structures and relative binding energies of involved aquo ions were calculated at the B3PW91/UGBS level of theory. Harmonic frequencies were calculated to verify that calculated geometries represent minima (zero imaginary frequencies). The calculations were conducted using the GAUSSIAN16 suite of programs and relative energies were calculated as free energy differences (298.15 K) between the aquo ions, the sum of energies of metal ion, and an appropriate number of water molecules. The aqueous medium was mimicked using the polarizable continuum model (PCM) by Tomasi and coworkers. All complexes were optimized in the highest possible symmetry.

### Example 3: Chemical Aspects

Salts employed were a majority chlorides, with exceptions of Ce(NO₃)₃ and Nb (NO₃)₅. The salts were purchased from Aldrich with a purity of >99% and used without further purification. All the utilized carboxylic acids were purchased from Aldrich with a purity of >97%. Brine solutions were prepared in different concentrations by dissolving the salts in de-ionized (DI) water while the hydrocarbon-acid phase such as C12 was always 1.6 mol percent with respect to dodecane, the model hydrocarbon. Dodecane was used because it resembles the physical properties of crude oil reasonably closely. The dodecane was purchased from Sigma Aldrich with a purity of 99% and further purified through a silica gel column to remove trace amounts of peroxide that may present in dodecane. The crude oils under study are all from Saudi assets, and total acid numbers (TAN) were measured using standard American Petroleum Institute (API) procedures. The spiking procedure involved 1.6 weight percentage (wt. %) rather than mole % because crude oil does not have a specific molecular weight.

### Example 4: IFT and Crystallization Studies

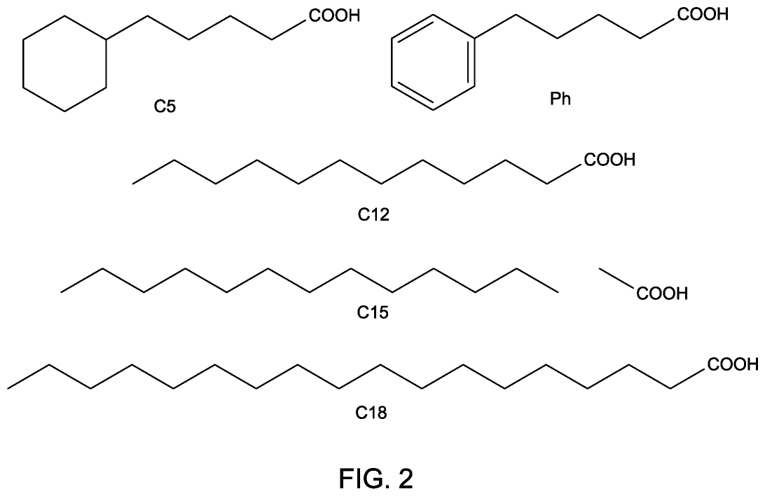

To test effect of a relationship of chelating cation types with carboxylic acids of various derivatives, five acids abbreviated as C5, C12, C15, C18 and Ph, as shown in FIG. 2, were utilized against several cations including Cr³⁺, Mn²⁺, Fe²⁺, Ni²⁺, Cu²⁺, Zn²⁺, Nb⁵⁺, Ce³⁺ and Nd^{3+. C}12 is also referred to as dodecanoic acid or lauric acid throughout the disclosure. These acids are simple models of naturally occurring surfactants, in which the hydrophilic head is the —COOH group, while the lipophilic part is the long aliphatic chain. The ions were chosen primarily because of variety of their electron configuration and their limited presence in both injection and formation water. The latter means that, when using the ions as potential additives, it will have the maximum impact as the cations enter a completely pristine environment.

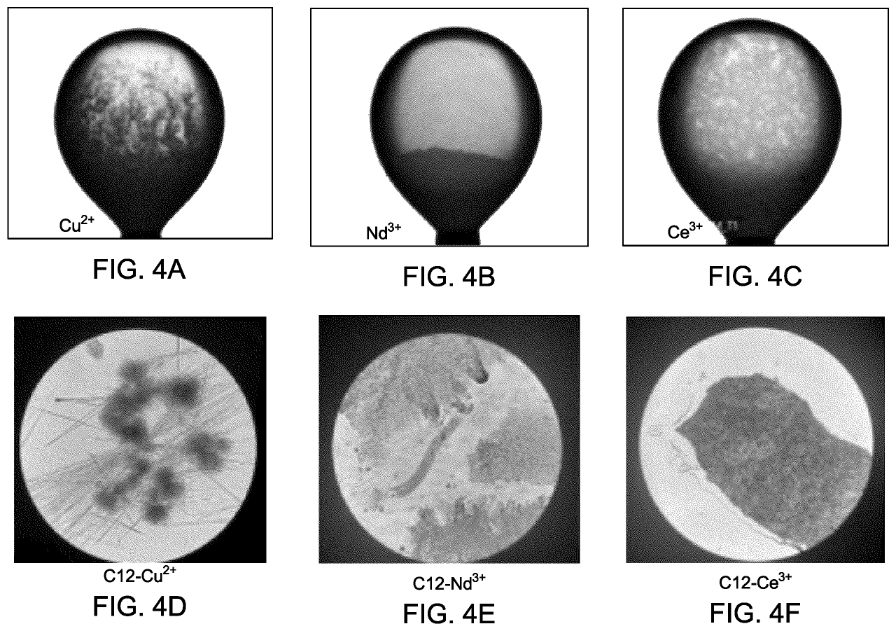

From this cation-acid matrix, only C5 and C12 show visual crystal formation with specific metal cations Zn²⁺, Cu²⁺, Nd³⁺, and Ce³⁺. FIGS. 4A-4F illustrate optical images of the formed crystals of some cations with C12. However, it does seem that C12 not only forms crystals the fastest but also crystals that may be the robust. The other acids do not form apparent crystals, this may be due to polarization effects induced by phenyl group in Ph or due to geometrical hinderance at the interface for longer chains such as C15 and C18.

From the buoyant droplet shapes, as shown in FIGS. 4A-4C, all crystals were formed at the interface, except Nd³⁺, where the crystal seeds are also forming inside the bulk and not only at the interface as in all the other cases. Subsequently, the crystallites settle gravitationally as shown in FIG. 4E. The coordination sphere of Nd³⁺ fits either water or acid groups at the interface in a way so that the overall charge becomes zero, which enables the solution in the hydrocarbon phase to ultimately induce crystallization inside the droplet.

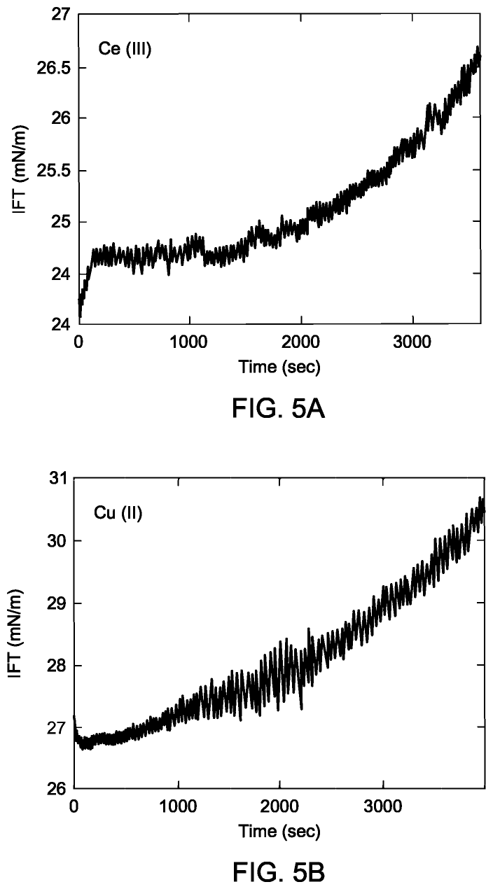

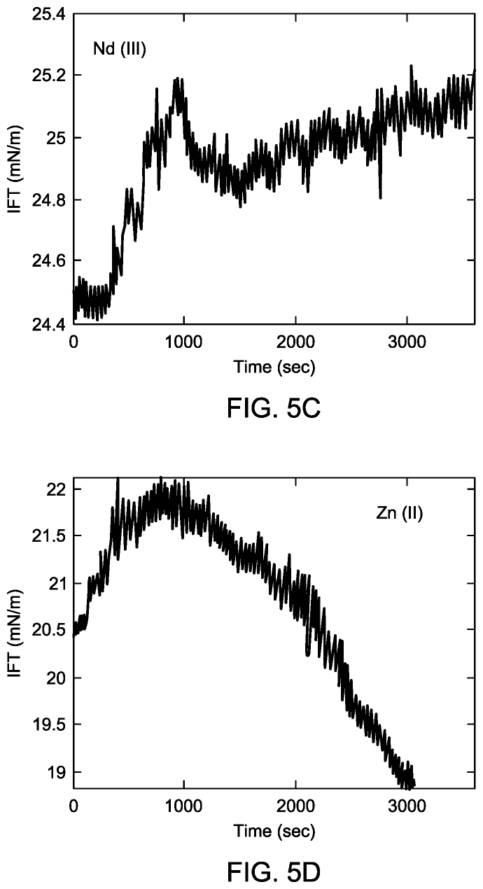

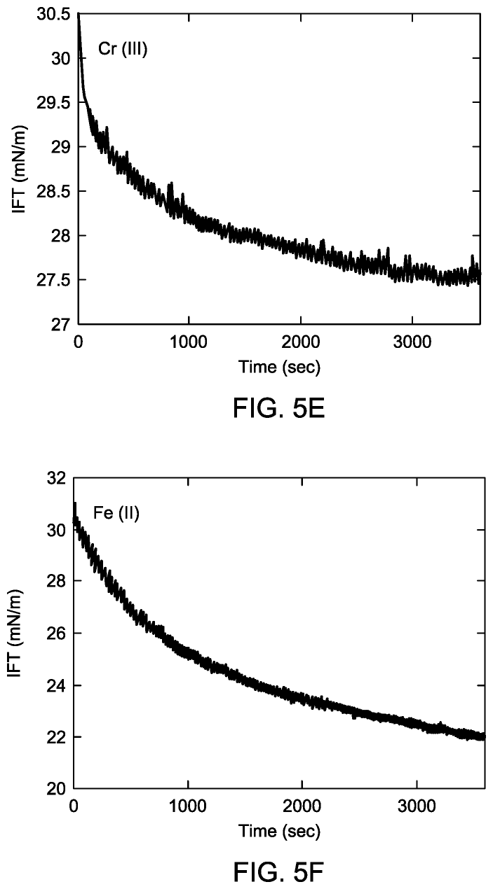

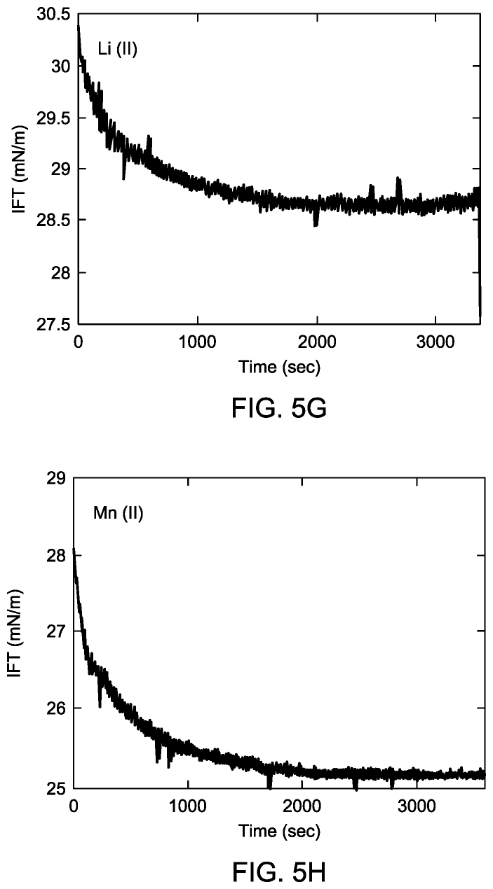

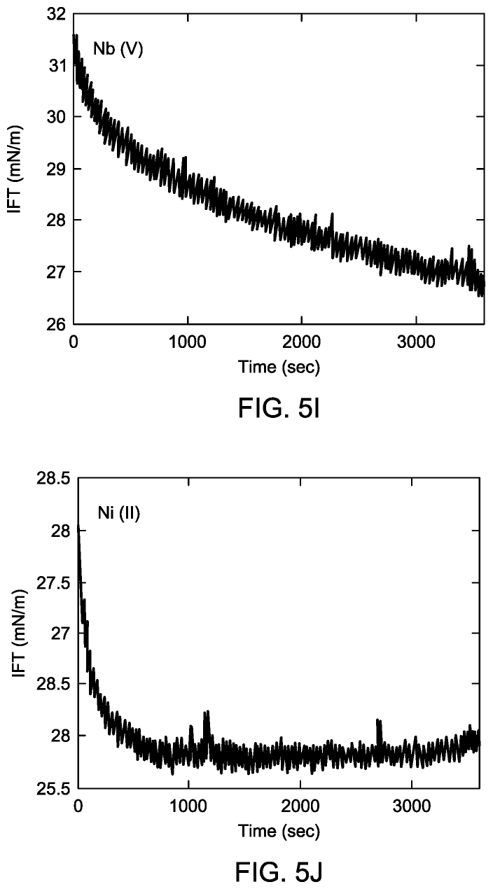

To track the effect of the crystal formation on the interfacial properties, IFT measurements were conducted during the crystallization process within 3000 seconds, as shown in FIGS. 5A-5J. The IFT observations were categorized into two general trends within experimental time frame. The first trend is characterized by an increase in the IFT values, which are also connected to the visualization of crystal formation. The second trend is characterized by a decrease in the IFT values, in which no crystals were observed. The role of the cations in the later trend may be associated with a realignment of the surfactants such as C12 by the metal ion additives at the brine-dodecane interface, an effect that is associated with double-layer potential.

A trend that is associated with IFT increase is considered a direct indication, for reorganization of ordered assembly of crystals with the added cation such as, Ce(III). Further, from the IFT behavior, there are two ongoing processes, reordering of acids, and solidification through crystal formation. The IFT response depends on which process is the dominating one. For instance, in the case of Ce(III), as shown in FIG. 5A, the IFT is increasing, indicating that the solidification process dominates. Conversely, in the case of Zn (II), as shown in FIG. 5D, an increase combined with a decrease was noticed, indicating a slow competitive process between surfactant ordering and solidification through crystallization, the same goes for the Nd (III), as shown in FIG. 5C. The pH is associated with the brine phase and the subsequent submerging of a dodecane/acid solution. The results were supportive of the chelation mechanism. The initial pH in the Cu and Zn cases was 5.0. It is described as weakly acidic since the water molecules that are associated to the metal ions are more easily deprotonated. The pH was reduced after the brine solution was exposed to the dodecane/acid solution. After 5 min the pH was 4 in the Cu case and 4.5 for Zn. The results indicate that the carboxylic acid was associated with the cation to subsequently provide a proton.

### Example 5: Theoretical Studies

To verify the experimental observations for a favorable formation of crystals with selected cations, theoretical calculations were performed. The cation variation spanned along a broad spectrum of different electron configurations and the structures of the associated hexa-coordinated and tetra-coordinated aquo ions, as cataloged in Table 1. In addition, metal cations have different electronic configurations. In an example, metal cations located in a d-shell were Cr³⁺, Mn²⁺, Fe²⁺, Ni²⁺, Cu²⁺, and Zn²⁺. Metal cations located in a f-shell were Ce³⁺ and Nd⁵⁺. Further, metal cation located in second period of transition metals were Nb³⁺. The variation in coordination structure was related to the variation in crystallization propensity.

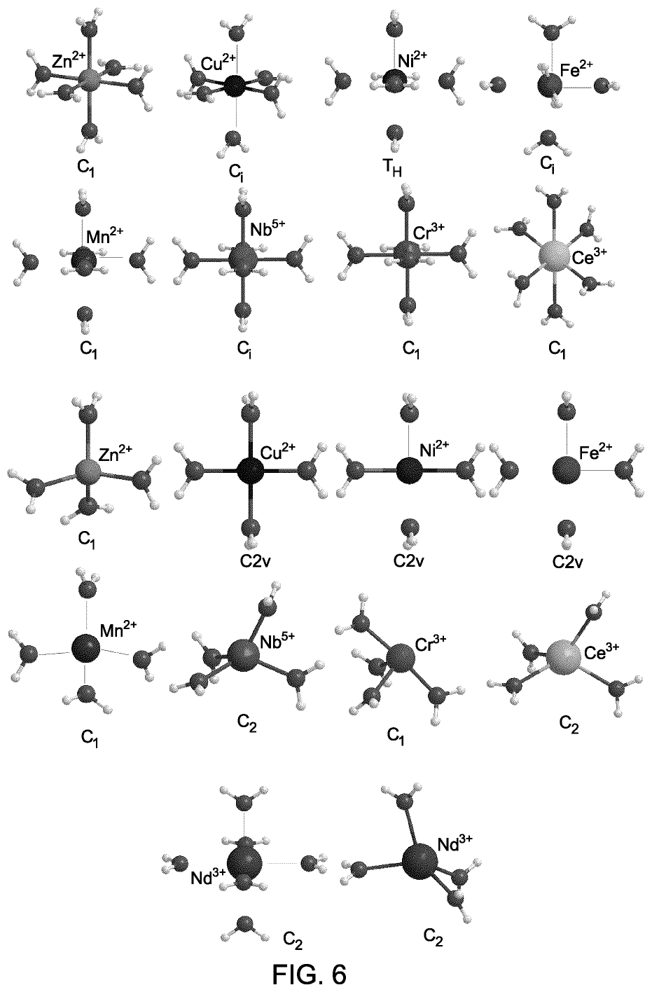

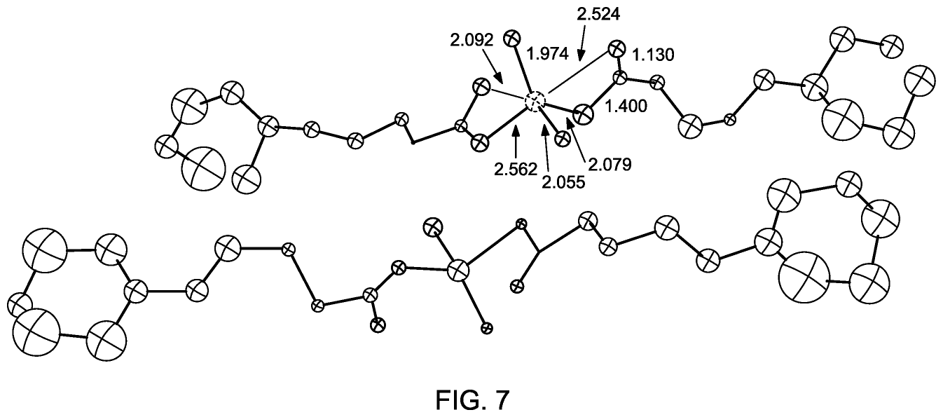

The calculated structures of tetra-aqua and hexa-aqua ions of the first-row transition metals were compared, showing completely different electron configurations, and associated completely different multiplicities, as shown in FIG. 6. Some of the cations in the number of surrounding water molecules did not sufficiently account for a proper coordination environment. However, the concentration of electrolytes in the subsurface was often so high that there were not enough water molecules to properly solvate the electrolytes. Thus, the calculations were conducted to determine relations between crystallization propensity, complex structure, and binding energies.

Carboxylic acids are bidentate with an approximate OCO angle of 120°. The structural match at the brine/hydrocarbon interface was better in some cases than others for the tetra-coordinated species whereas the hexa-coordinated species were all octahedral in nature with M-O bonds all being around 2 angstroms (Å). A solvent model is required to accurately evaluate the binding energies, but the hexa-aqua ions were most stable in solution for the results that were obtained with a polarizable continuum model (PCM). Whether this is also the case at the interface is not fully determined for all the ions, however, for Zn²⁺ it is the case based on a crystal structure that was obtained from a batch of isolated crystals, as shown in FIG. 7.

Overall, the binding energies determine the crystallization propensity rather than actual structure if the organic phase accommodates an octahedral structure at the interface. Furthermore, in the cases, where the octahedral structure is a possibility, what determines the crystallization propensity is the energy change in transforming an aquo ion into one that is coordinated to the interface with C12. There were differences in the symmetry of the complexes. A clear trend to indicate when high symmetry prevails over low symmetry is not identified. However, both Cu²⁺ and Zn²⁺ form crystals in the same manner, but the symmetry of the involved complexes differs. Thus, it may be concluded that there was no relation between crystallization and symmetry. The calculated binding energies are shown in Table 1. There is no relation between crystallization propensity and binding energies except for a fixed energy gain (in all but three cases) in going from 4 water molecules to 6 water molecules.

### Example 6: Crystal Formation and Mechanism

A plausible mechanism for crystal formation at water-oil interfaces was drawn from the above stated description. C12 stood out as being the acid with the highest propensity for crystal formation. This is due to a combination of binding strength of the cation with the acid, and favorable orientation of the acid at the interface. Only certain acids give rise to crystallization such as, those with a chain that is structured to fit into the bulk to orient and thereby place the acid group at the interface.

Further, due to environmental and economic aspects, the Zn(II) cation was used for further applications in the oil industry. The fundamental reason for variation in crystallization propensity was due to the electronic orbital that acts as an acceptor on the cation. In particular, cations with an empty s orbital undergo crystallization. In general, the s-orbital is spherical in nature, providing a binding environment different compared to a binding environment as provided by a d-orbital. The orientational aspects were important during anchoring of the cation at an interface, as the electron donor space is highly structured.

TABLE 1
Binding energies (kcal/mol) for various cations
with tetra- and hexa-water chelation.

| Cation (X) | Crystals formed* | X (H₂O₄) | X (H₂O₆) | ΔE |
|---|---|---|---|---|
| Zn²⁺ | Yes | 58.9 | 75.3 | 16.5 |
| Cu²⁺ | Yes | 163.5 | 181.6 | 18.1 |
| Ni²⁺ | No | 69.1 | 100.5 | 31.1 |
| Fe²⁺ | No | 30.7 | 49 | 18.3 |
| Mn²⁺ | No | 173.7 | 189.3 | 18.4 |
| Nb⁵⁺ | No | 229.7 | 279.6 | 49.8 |
| Nd³⁺ | Yes | 223.2 | 238.1 | 14.9 |
| Ce³⁺ | Yes | 39.4 | 58 | 18.6 |
| Cr³⁺ | No | 146.9 | 199.8 | 52.9 |

### Example 7: Applications with Crude Oil Samples

The interfacial behavior involving three crude oils that differ in the acid content, as indicated by the TAN=1.9, 2.8 and 3.3, respectively, is described. To artificially enhance the crystallization propensity, the crude samples were spiked with 1.6 wt. % of C12. Thus, applications targeting conformance control involved injection of slugs of both Zn²⁺ brine and C12. The above-mentioned procedure was performed with respect to the composition of the oil.

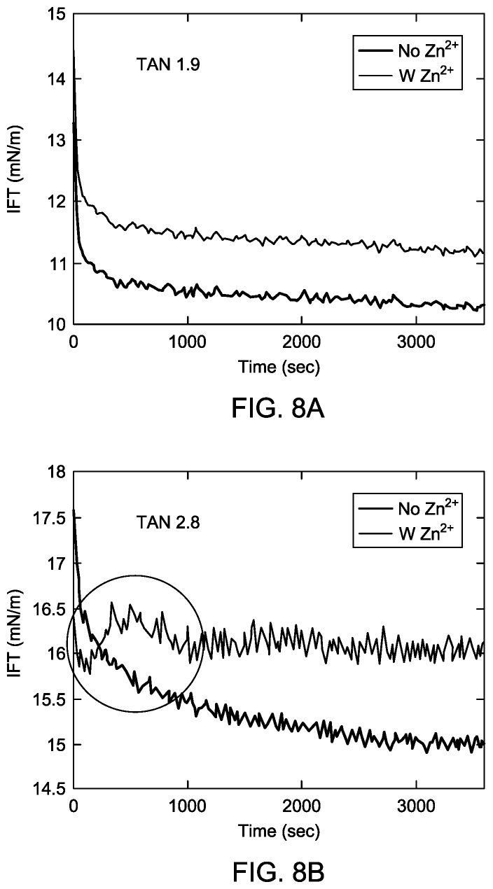

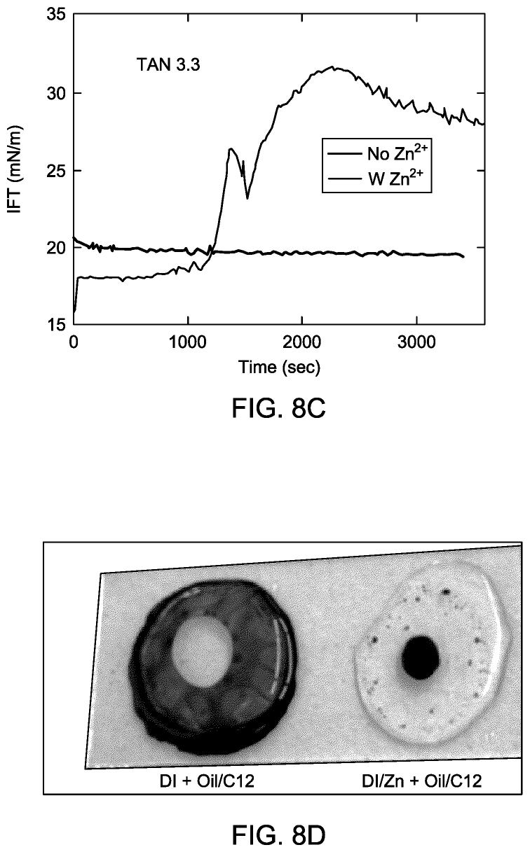

FIGS. 8A-8D illustrate the change in the IFT values with time for three oil samples with different TAN, in the presence of Zn²⁺ and in the absence of Zn²⁺. In the absence of Zn²⁺, the mixture of the oil sample with the C12 acid showed a rapid decrease in the IFT value immediately upon contact between the Zn²⁺ and oil mixture. The scope of realignments of C12 acid at the interface between the oil and brine environment was independent of the acid content in the crude oil. For the oil samples without 1.6 wt. % C12, the IFT increased with increasing TAN. The opposite trend showed that molecules other than acids were contributing towards a lowering of the IFT.

Further, upon adding Zn²⁺ to the mixture, the IFT behavior was changed and depended on the acid value of the oil. In general, a higher degree of crystallization occurred as the TAN increased. For the oil sample with TAN=1.9, the IFT value was slightly more than the one without Zn²⁺, indicating partial crystallization that led to rise in the IFT. For the oil sample with TAN=2.8, the initial IFT value was lower than the control sample. However, an increase in IFT accompanied by a hub was noticed. For the TAN=3.3 sample, similar observations were recorded but with an increase of IFT (about 50% increase) after about 1000 seconds, due to the crystallization of Zn²⁺ with C12 at interfaces. These results indicate that the oil samples with TAN=1.9 and TAN=2.8 contain a large fraction of basic components, which may interact with the added C12 to result in a reduced effective concentration at the interface.

Referring to FIG. 8D, upon adding the Zn²⁺ solution to the mixture of oil and C12 acid, a mass transport between two immiscible phases with a hydrocarbon droplet was observed. The above-mentioned effect plays out in conjunction with hydrocarbon phases with added C12 and brine with electrolytes that impacted the interfacial properties, that is, the Cu²⁺ and Zn²⁺ of the compounds that were investigated. In the case of Zn²⁺ brines, a crystalline confinement forms around the hydrocarbon droplet to shrink the droplet significantly.

The aspects of the present disclosure describe the method treating the oil spill based on crystallization at oil/brine interface. The present disclosure is based on an interfacial-driven phenomenon in the presence of zinc ions and long-chain acids such as, but not limited to, dodecanoic acid. The long-chain acid promotes in-situ crystallization at the oil/brine interface, leading to the confinement of hydrocarbon drops in relatively smaller areas. By spreading a solution including zinc ions at a concentration of around 2500 ppm to 10000 ppm, and 0.5 wt. % to 2.0 wt. % of dodecanoic acid (C12) on the hydrocarbon spill area, the spill may be contained in an efficient manner and protect further polluting of environment. The crystal formation at a hydrocarbon/surfactant-brine interface is determined by the electron configuration of the cations in the brine and the orientation of the surfactants at the interface. Only certain surfactant solutions in combination with certain brines give rise to crystals at the interface between the immiscible phases that are involved. A favorable combination of a straight chain acid C12 and environmentally acceptable Zn²⁺ cations is identified. The mechanism for forming the first crystal seeds is adhesion at the surface. A prerequisite may be that the TAN of the oil spill to be treated is rather high and that acids are not much longer than C12.

This formulation is applied as shown in FIGS. 1D-1I. The method involved mixing zinc chloride with lauric acid using acetone, glycerol, or ethanol as a solvent. In the present example, acetone was used. Initially, lauric acid was diluted into acetone. The concentration used was 1.7-3 weight percent of lauric acid in 5-10 ml of acetone. Separately, zinc chloride was dissolved into water with 2-3 moles of zinc chloride per liter. Next, the zinc chloride solution was slowly introduced into the lauric acid-acetone mixture, ensuring the solvent becomes saturated with the zinc chloride solution. Once the product was completed, a droplet was added into a mixture of crude oil with water (FIG. 1D) and the crystallization reaction at the interface took place (FIGS. 1E-1I), where the surface area of the crude oil was smaller in FIG. 1I than before the addition of the formulation in FIG. 1D.

The order of combining the components was significant in order to provide a coalesced oil layer. In this method, reversing this process did not provide the same results, as zinc chloride does not effectively dissolve into the solvent (acetone). Despite to the fact that organic (lauric acid in acetone) and inorganic (zinc chloride in water) are not miscible, when combined into a single product for a short process, i.e., applied to the oil spill right after the formulation is made, a better performance was achieved than the following comparative example depicted in FIGS. 1J-1N.

In FIGS. 1J-1N, the same components were included in similar amounts, however, the solutions were prepared and applied in a different order. FIG. 1J is a mixture of crude oil and sea water. FIG. 1K shows the mixture after lauric acid was added. In FIG. 1L a droplet of ZnCl₂ was then added into the mixture. Then the reaction of the components took place where the crystallization at the oil/brine interface led to hydrocarbon drops confinement in a smaller area as shown in FIGS. 1M-1N. Although, the oil layer did coalesce in this method, the surface area and overall shape of the oil is less favorable compared to the previous method as shown in FIG. 1I. This would result in difficulties collecting the oil.

Numerous modifications and variations of the present disclosure are possible in light of the above teachings. It is therefore to be understood that within the scope of the appended claims, the invention may be practiced otherwise than as specifically described herein.

1: A method of treating an oil spill, comprising;
first making a formulation, comprising:
mixing an acid and a solvent to form a first solution;
mixing a zinc (II) salt and water to form a second solution; and
adding the second solution to the first solution to form the formulation,
wherein the acid comprises a carboxylic acid group and at least 10 carbon atoms,
wherein the first solution comprises 1-10 wt. % of the acid relative to a total weight of the first solution, and
wherein the second solution comprises 1-10 moles of the zinc (II) salt per liter of the water, then
contacting the formulation with the oil spill,
wherein the oil spill comprises an aqueous medium and an oily layer on the aqueous medium, and
wherein the contacting coalesces the oily layer.

2: The method of claim 1, wherein the zinc (II) salt is zinc (II) chloride, and
wherein during the contacting in-situ crystallization of the zinc (II) chloride occurs at an interface of the aqueous medium and the oily layer to form a crystalline confinement around hydrocarbon droplets in the oily layer.

3: The method of claim 1, wherein the acid comprises the carboxylic acid group and 10-14 carbon atoms in a straight chain.

4: The method of claim 1, wherein the acid is dodecanoic acid.

5: The method of claim 1, wherein the second solution further comprises at least one selected from a copper (II) salt, a nickel (II) salt, an iron (II) salt, a manganese (II) salt, a niobium (V) salt, a neodymium (III) salt, a cerium (III) salt, and a chromium (III) salt.

6: The method of claim 1, wherein the second solution further comprises a copper (II) salt.

7: The method of claim 1, wherein the first solution comprises 1-3 wt. % of the acid relative to a total weight of the first solution.

8: The method of claim 1, wherein the second solution comprises 2-3 moles of the zinc (II) salt per liter of the water.

9: The method of claim 1, wherein the solvent is selected from acetone, glycerol, and ethanol.

10: The method of claim 1, wherein the adding is dropwise.

11: The method of claim 1, wherein the first solution is saturated with the second solution in the formulation.

12: The method of claim 1, wherein contacting is within 30 minutes after the formulation is made.

13: The method of claim 1, wherein the formulation does not comprise a gel.

14: The method of claim 1, wherein the formulation does not comprise a polymer.

15: The method of claim 1, wherein the oily layer is crude oil.

16: The method of claim 1, wherein the coalesced oily layer has a total surface area at least 10% smaller than a surface area of the oily layer prior to the contacting.

17: The method of claim 1, wherein the contacting includes adding a volume of the formulation that is 1-50% of a total volume of the oily layer.

18: The method of claim 1, further comprising deploying a first drone to assess a size of the oil spill prior to the making the formulation.

19: The method of claim 18, further comprising deploying a second drone containing the formulation,
wherein the second drone contacts the formulation with the oil spill.

20: The method of claim 19, further comprising deploying a boat to collect the coalesced oily layer.
